(19) United States
(12) Patent Application Publication
(10) Pub. No.: US 2025/0129592 A1
(43) Pub. Date: Apr. 24, 2025

(54) FILTER SYSTEM MOUNTABLE IN A CURBSIDE STORM DRAINAGE BASIN

(71) Applicant: Fabco Industries Inc., Hauppauge, NY (US)

(72) Inventor: John Peters, JR., Coram, NY (US)

(21) Appl. No.: 18/924,028

(22) Filed: Oct. 23, 2024

Related U.S. Application Data
(60) Provisional application No. 63/545,277, filed on Oct. 23, 2023.

(51) Int. Cl. E03F 5/14; B01D 29/11

(52) U.S. Cl. CPC E03F 5/14; B01D 29/114

(57) ABSTRACT

A storm water trough filter system is mountable in a storm vault having interior walls and a storm water inlet formed in at least one of the interior walls which allows storm water to flow therethrough and into the storm vault. The storm water trough filter system has at least one trough section which defines a water trough for receiving storm water flowing into the storm vault through the storm water inlet thereof. The storm water trough filter system further includes at least one mounting bracket which is affixable to at least one of the interior walls of the storm vault, the at least one trough section being mountable on the at least one mounting bracket. The storm water trough filter system further includes a filtering apparatus having a water permeable filtering medium. The water trough defined by the at least one trough section is in fluid communication with the water permeable filtering medium of the filtering apparatus to direct storm water received by the water trough to the filtering medium of the filtering apparatus.

### CROSS-REFERENCE TO RELATED APPLICATIONS

This application is related to U.S. Provisional Application Ser. No. 63/545,277, filed on Oct. 23, 2023, and titled “Filter System Mountable In A Curbside Storm Drainage Basin”, the disclosure of which is incorporated herein by reference and on which priority is hereby claimed.

### BACKGROUND OF THE INVENTION

### Field of the Invention

The present invention generally relates to storm water drainage systems, and more particularly relates to drainage systems which are mountable in storm water catch basins having open-curb storm water inlets.

### Description of the Prior Art

Storm water drainage systems are commonly used in streets, highways, parking lots and other paved surfaces throughout the United States and in foreign countries, especially in urban developments, to remove water accumulating on the surfaces thereof. In many municipalities, curbside storm vaults, or storm water catch basins, are installed below grade along such paved roadways. Such catch basins are usually formed from concrete and are connected to a conduit that channels the storm water away from the area to a relatively large water collection reservoir, or to a river, stream or other body of water.

A typical storm vault 2 which is used extensively in the streets of many municipalities in the United States is shown in FIG. 1 of the drawings. Such storm vaults 2 are usually made from concrete and are rectangular in transverse and longitudinal cross-sections, i.e., the vaults 2 are formed as a rectangular parallelepiped, with opposite front and rear side walls, opposite lateral side walls, a bottom wall and a top cover wall. The walls of the storm vault 2 define an interior cavity which receives storm water through an elongated, curbside opening, or open-curb storm water inlet 4, formed in the front wall of the concrete vault 2, the vault 2 being positioned in the ground such that the curbside opening 4 is level with the surface of the paved roadway to receive runoff water accumulating on the roadway therethrough and into the internal cavity of the vault 2, where the water is directed to a channeling conduit forming part of the storm water drainage system. Such storm vaults 2 may take on many different dimensions in width, depth and height.

Many municipalities throughout the United States now require filtering apparatus to be placed inside the storm vault 2 or catch basin in order to filter coarse materials and debris, such as leaves, stones, branches and manmade trash, and fine material, such as sediment and sand, carried by storm water that enters the storm vault 2 through the curbside opening 4 formed therein and that collects within the internal cavity of the storm vault 2. Such coarse debris material and sediment may clog the drainage conduit connected to the storm vault 2 and may contribute to the pollution of the body of water to which the storm water from the catch basin (storm vault) 2 collects.

The dimensions and construction of such storm vaults 2 create major design constraints on any filter system for use in such storm vaults 2. Since all of the storm water flowing through the curbside opening 4 must be diverted to flow into the filtering apparatus, the structure of the filter system that collects the storm water and directs the water to a filtering medium must extend across the full width of the curbside opening of the storm vault 2.

The elongated curbside opening 4 or slot of the storm vault 2 is rather narrow in height, perhaps about two inches to about six inches, but varies greatly in width, for example, from about two feet to about eight feet, or more, depending on the size of the storm vault 2 a municipality chooses for its roadways. On some roadways, the storm vault 2 may be positioned at a street corner, and the curbside opening 4 may take on a corresponding right angle or corner shape. Conventional filter systems which are designed to be mountable in such curbside storm drainage basins are not configurable to accommodate the various widths and shapes of the curbside opening 4, and must be custom made to catch all of the storm water, and debris and sediment carried thereby, flowing through the curbside opening 4.

As can be seen in FIG. 1 of the drawings, there is also an access opening 6 formed through the thickness of the cover wall of the storm vault 2, which access opening 6 is covered by a storm grate or a manhole cover 8. The manhole cover 8 is typically about eighteen inches in diameter, and it rests on and is supported by a steel flange or lip within the access opening 6, which renders the access opening 6 even smaller in diameter than that of the manhole cover 8. The relatively small diameter of the access opening 6 also limits the size of any filtering apparatus that may be placed in the storm vault.

Furthermore, the location of the vault access opening 6 may vary from storm vault to storm vault. It would be desirable and more practical to locate the filtering medium directly below the steel grate or manhole cover 8 and in alignment with the access opening 6 so that the filtering medium may be easily accessed by municipal workers for cleaning or replacement. Many conventional filter systems are not adaptable to align the filtering medium with the vault access opening and, accordingly, need to be custom made to achieve this.

Additionally, the storm vault 2, typically being formed from concrete, is not perfectly rectangular in its cross-sectional dimensions. Corners are typically not at right angles as one would expect, and irregularities in the concrete of the internal surfaces of the side walls must be considered and addressed in the construction of any filter system that is mountable within a storm vault.

### OBJECTS AND SUMMARY OF THE INVENTION

It is an object of the present invention to provide a filter system mountable in a curbside storm drainage vault or basin which is configurable to accommodate the many widths and shapes of the vault's curbside opening.

It is another object of the present invention to provide a filter system which supports a removable filtering apparatus and which positions the filtering apparatus directly under and in alignment with a manhole cover or storm grate to facilitate access to the filtering apparatus for removal of debris collected thereby.

It is still another object of the present invention to provide a filter system mountable in a curbside storm drainage vault which is provided as a kit that can be easily assembled to an expandable form and which is positionable under the full width of a curbside opening forming part of the storm vault.

It is a further object of the present invention to provide a filter system for use in a curbside storm drainage vault that includes interconnecting trough sections and a filtering apparatus supported thereby, whereby the filter system may be expandable to divert water entering the storm vault through the entire width of the curbside opening thereof and direct the storm water to the filtering apparatus.

It is yet a further object of the present invention to provide a configurable filter system which is mountable on just one wall of the storm vault and, therefore, there is no need to take into consideration the irregularities of either the walls or the corners of the interior cavity of the storm vault.

In accordance with one form of the present invention, a configurable storm water open-curb inlet trough filter system is provided, which collects incoming street debris carried by storm water entering the open-curb inlet of a storm vault and channels it to a removable filtering apparatus, preferably in the form of a sack or sock made from a geotextile material, which is located directly under the manhole cover or steel grate for easy and convenient maintenance operations. The filter system is made from interconnecting components of various lengths and configurations to fit many standard open-curb inlet sizes. The components of the filter system are assembled within the storm vault to accommodate the internal vault dimensions so that it extends across the entire width of the open-curb inlet, including those corner inlets that have right angle dimensions.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of one form of a typical storm water catch basin or storm vault in which the filter system of the present invention is mountable.

FIG. 2 is a front perspective view of an assembled filter system formed from interconnectable components and constructed in accordance with the present invention, the filter system being designed to be mounted in a curbside storm drainage vault having an eight foot curb inlet.

FIG. 3 is a front perspective view of the assembled filter system of the present invention shown in FIG. 2 taken at a different viewing angle than that of FIG. 2.

FIG. 4 is a top plan view of the assembled filter system of the present invention shown in FIGS. 2 and 3.

FIG. 5 is a front elevational view of the assembled filter system of the present invention shown in FIGS. 2-4.

FIG. 6 is a front perspective view of an assembled filter system constructed in accordance with another form of the present invention.

FIG. 7 is a front perspective view of an assembled filter system constructed in yet another form of the present invention.

FIG. 8 is an exploded perspective view of the filter system of the present invention shown in FIG. 7.

FIG. 9 is a bottom perspective view of an assembled filter system constructed in accordance with another form of the present invention.

FIG. 10A is a front perspective view of a left endcap section defining a component of the filter system of the present invention, a right endcap section of the present invention being the mirror image of the left endcap section shown in FIG. 10A.

FIG. 10B is a front perspective view of a straight trough section defining a component of the filter system of the present invention, the straight trough section preferably being formed in widths of three inches, six inches, twelve inches and twenty-four inches.

FIG. 10C is a front perspective view of a corner trough section defining a component of the filter system of the present invention.

FIG. 10D is a front perspective view of a basket tray having mounted therein and supporting a removable filtering apparatus, each of which define components of the filter system of the present invention.

FIG. 10E is a front perspective view of a support leg which is connectable to the basket tray shown in FIG. 10D, the support leg defining a component of the filter system of the present invention.

FIG. 10F is a front perspective view of a portion of a strut channel defining a component of the filter system of the present invention.

FIG. 10G is a front perspective view of a wing diverter defining a component of the filter system of the present invention.

FIG. 10H is a front perspective view of a portion of the filter system of the present invention, illustrating the attachment of the support leg shown in FIG. 10E to the basket tray shown in FIG. 10D.

FIG. 10I is a front perspective view of a twenty-four inch straight trough section defining a component of the filter system of the present invention.

FIG. 10J is a rear perspective view of the wing diverter shown in FIG. 10G and defining a component of the filter system of the present invention.

FIG. 10K is a front perspective view of a corner expansion kit comprising the corner trough section shown in FIG. 10C assembled with a plurality of different sized straight trough sections shown in FIG. 10B, the corner expansion kit forming part of the filter system of the present invention.

FIG. 11 is a front perspective view of an assembled filter system formed in accordance with the present invention and illustrating how the filter system may be used with a storm vault having a water inlet or curbside opening extending around a corner of a roadway or intersecting roadways.

FIG. 12 is a partially exploded, top perspective view of a storm vault shown in partial transparency with the top cover wall thereof omitted, and illustrating the positioning of the filter assembly of the present invention prior to being installed in the storm vault.

FIG. 13 is a top perspective view of a storm vault with the top cover thereof omitted, and illustrating the filter system of the present invention being mounted therein and in alignment with the curbside opening of the storm vault.

FIG. 14 is a rear perspective view of a storm vault shown partially in transparency and illustrating the filter system of the present invention being mounted therein.

FIG. 15 is a partially exploded, top perspective view of a storm vault and the filter system of the present invention mounted therein.

FIG. 16 is a partially exploded view of a storm vault, with the top cover thereof shown in transparency, and illustrating the filter system of the present invention mounted therein with the filtering apparatus thereof shown being in alignment with the access opening of the storm vault.

FIG. 17 is a partially exploded view of a storm vault, with the top cover thereof shown in transparency, and illustrating the filter system of the present invention being mounted therein and further illustrating the filtering apparatus of the filter system being in alignment with the access opening of the storm vault.

FIG. 18 is a top plan view of a storm vault having the filter system of the present invention mounted therein and with the manhole cover omitted from the drawing, and illustrating the alignment of the filtering apparatus of the filter system of the present invention with the access opening of the storm vault.

FIG. 19 is a rear perspective view of the filter system of the present invention shown mounted in a storm vault, the storm vault being shown in partial transparency.

FIG. 20 is a rear perspective view of a portion of the filter system of the present invention mounted in a storm vault, the storm vault being shown in transparency.

FIG. 21 is a perspective view of a storm vault having a side wall thereof omitted and illustrating the filter system of the present invention being mounted therein directly underneath the curbside opening of the storm vault.

FIG. 22 is a partially exploded, front perspective view of a portion of the filter system of the present invention being mounted in a storm vault.

FIG. 23 is a partially exploded, front perspective view of a portion of the filter system of the present invention being mounted in a storm vault.

FIG. 24 is a perspective view of a portion of the strut channel of the filter system of the present invention, as also shown in FIGS. 10F and 23, mounted to an inner surface of the front wall of the storm vault and under the curbside opening thereof.

FIG. 25 is a perspective view of a portion of the strut channel of the filter system of the present invention shown in FIG. 24 mounted to the inside surface of the front wall of a storm vault, and illustrating spring-biased channel nuts positioned on the strut channel.

FIG. 26 is an exploded perspective view of a removable filtering apparatus defining a component of the filter system of the present invention.

FIG. 27 is a rear perspective view of a straight trough section defining a component of the filter system of the present invention, the straight trough section being shown with a reverse-angled flange and water seepage holes.

### DETAILED DESCRIPTION OF THE PREFERRED EMBODIMENTS

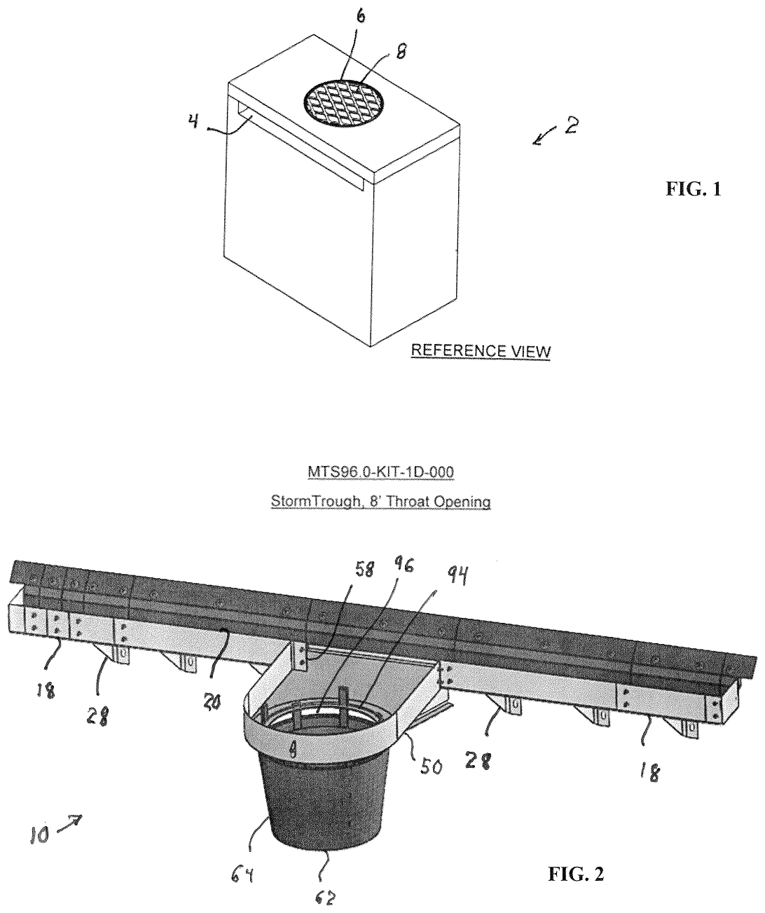

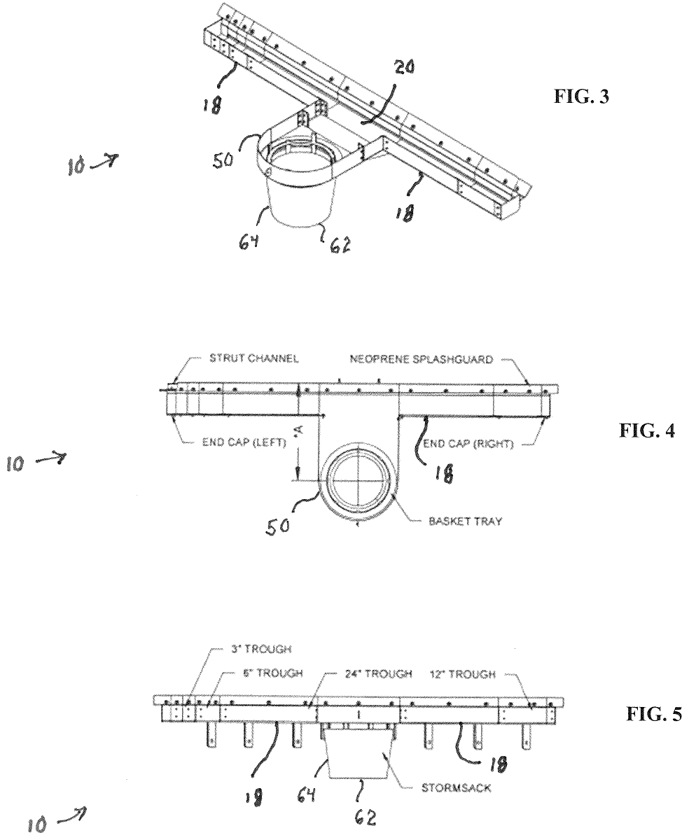

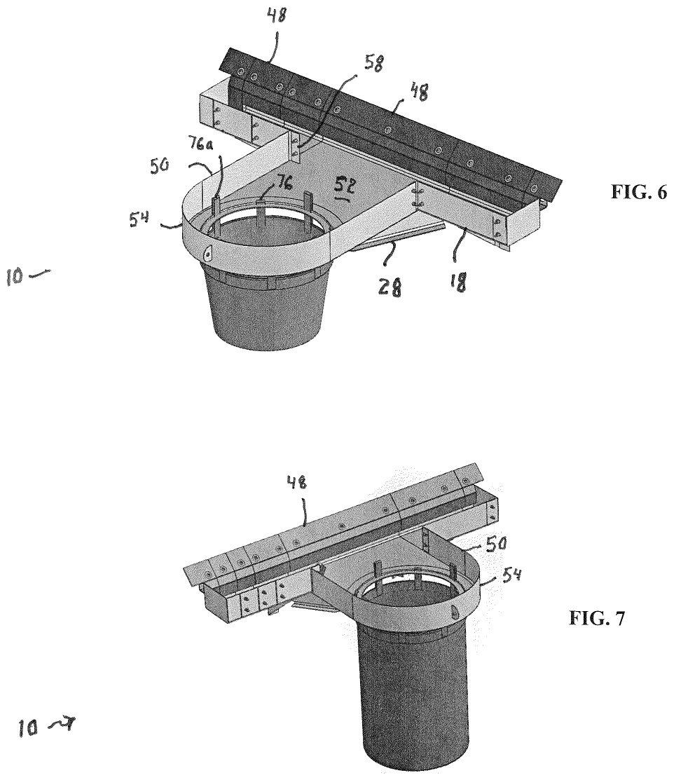

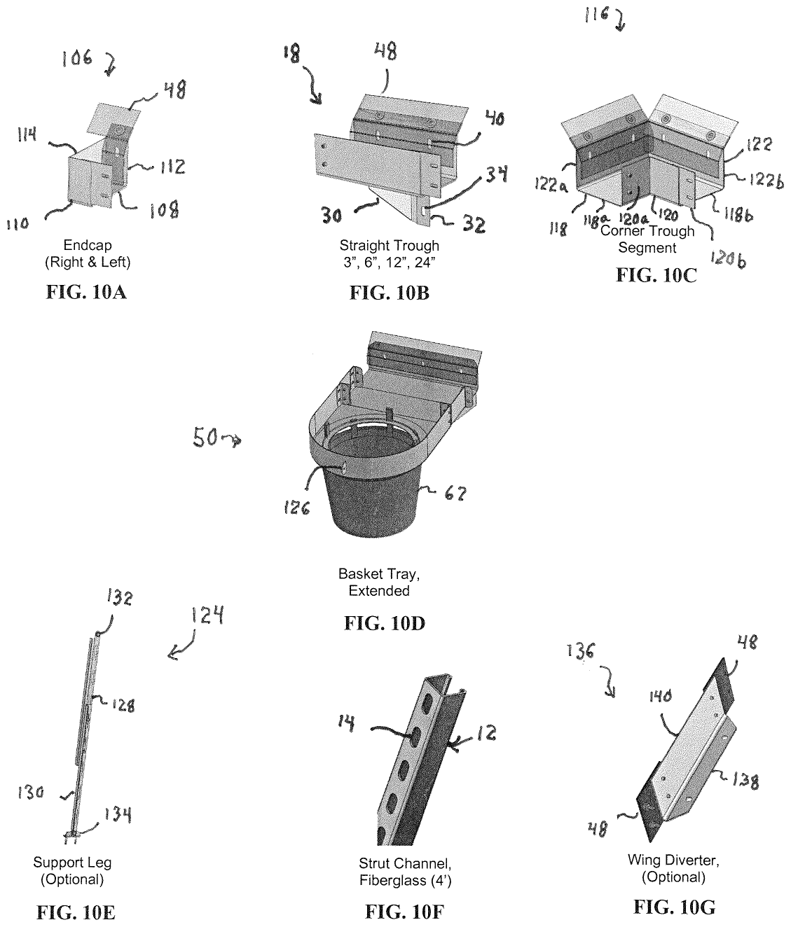

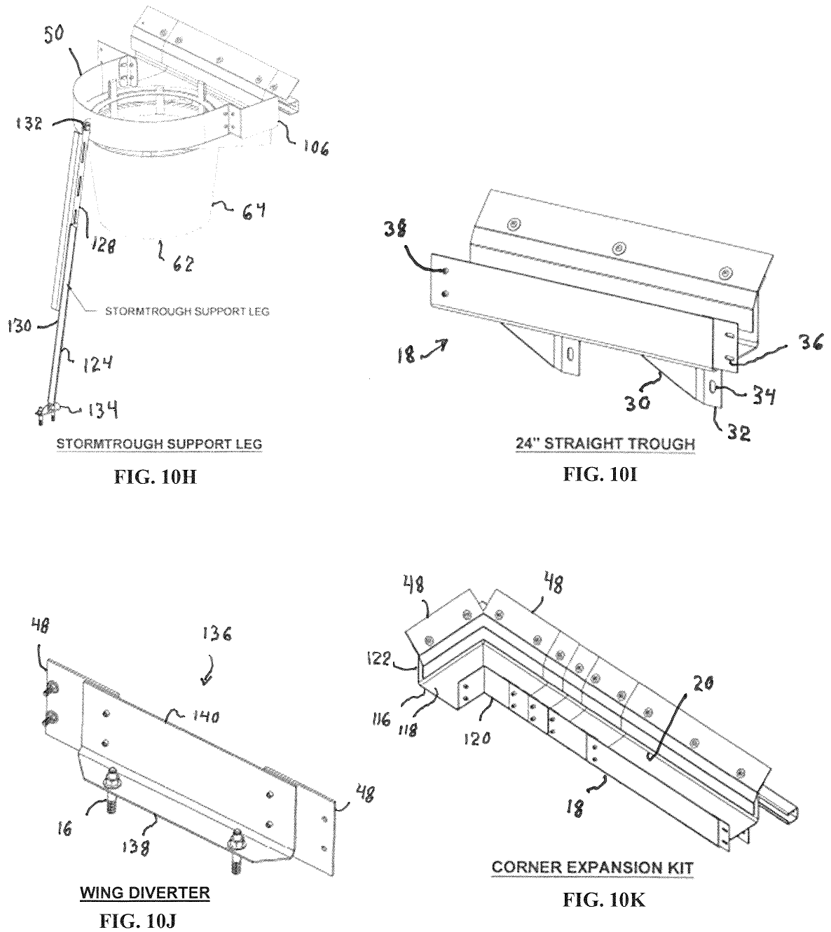

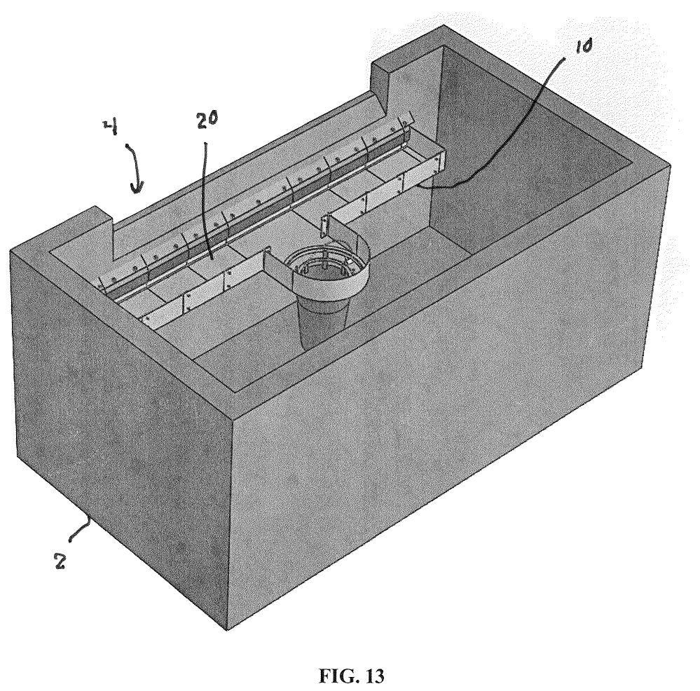

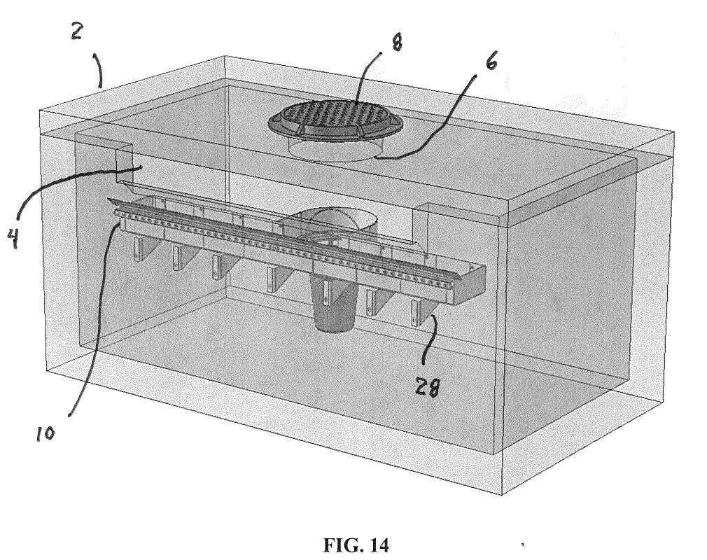

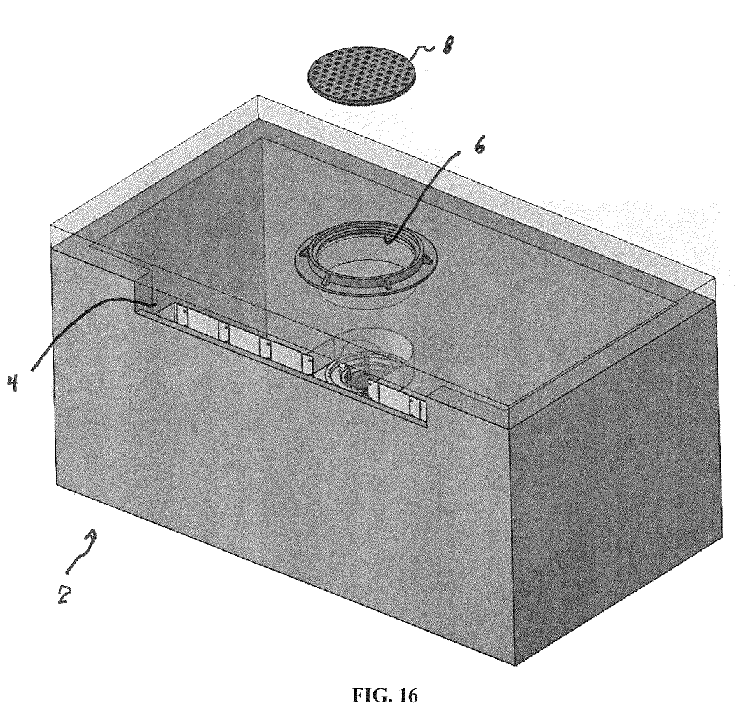

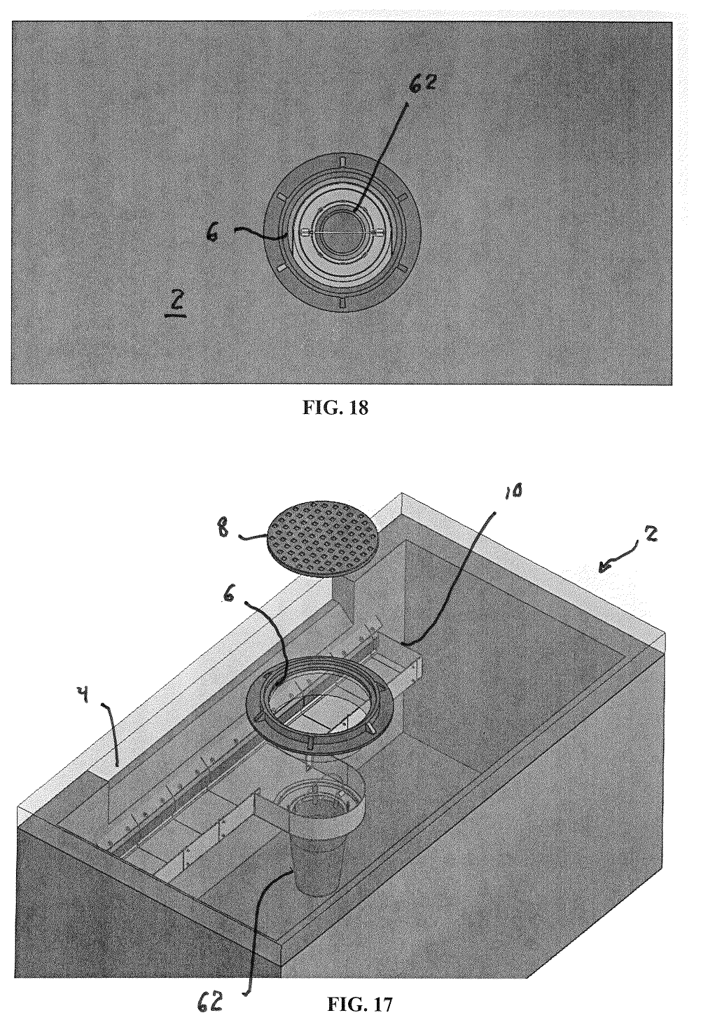

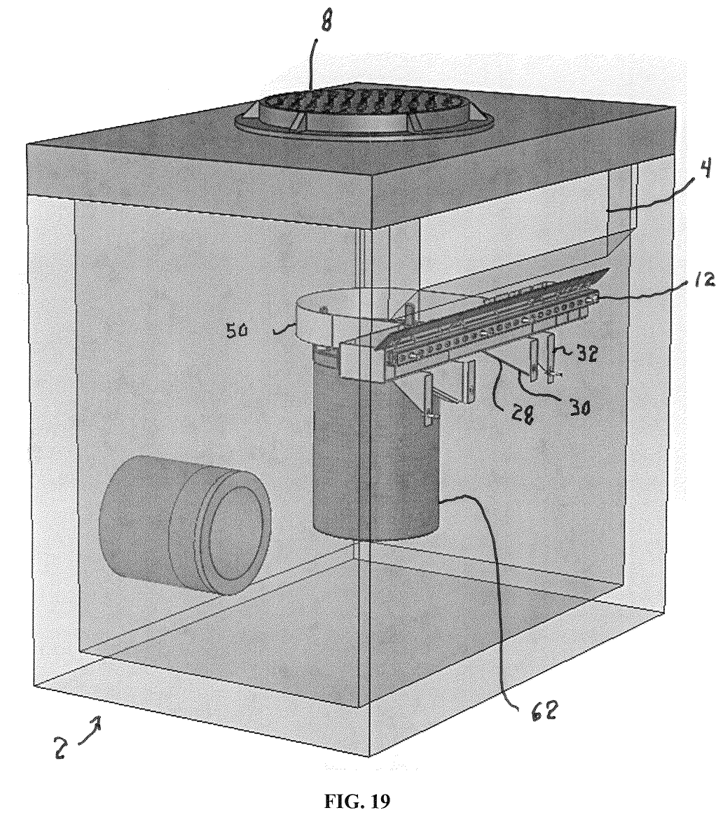

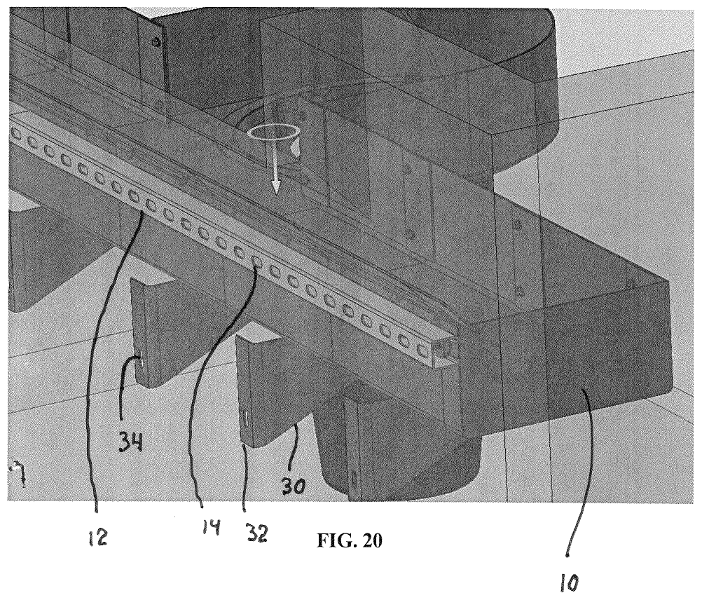

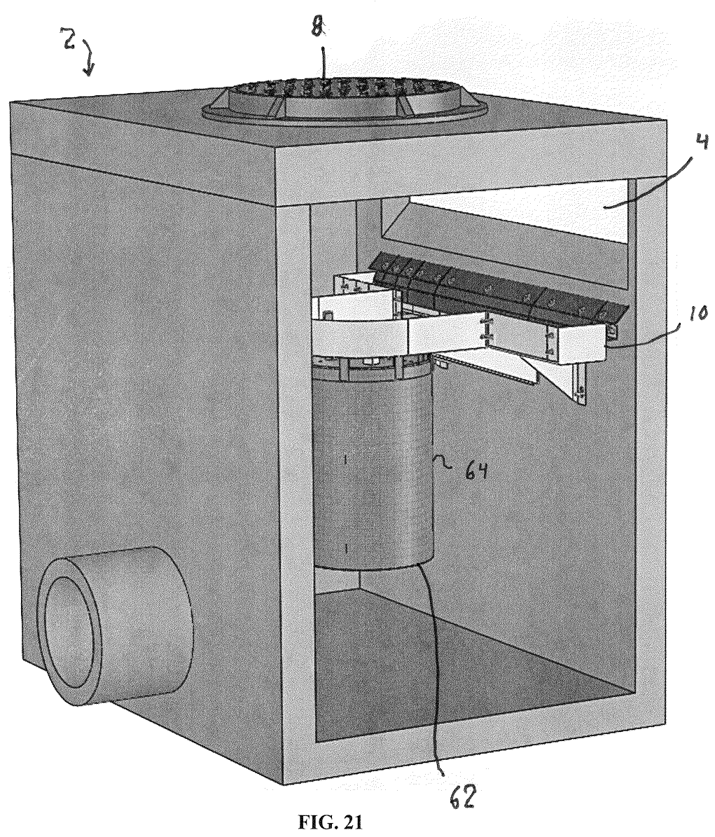

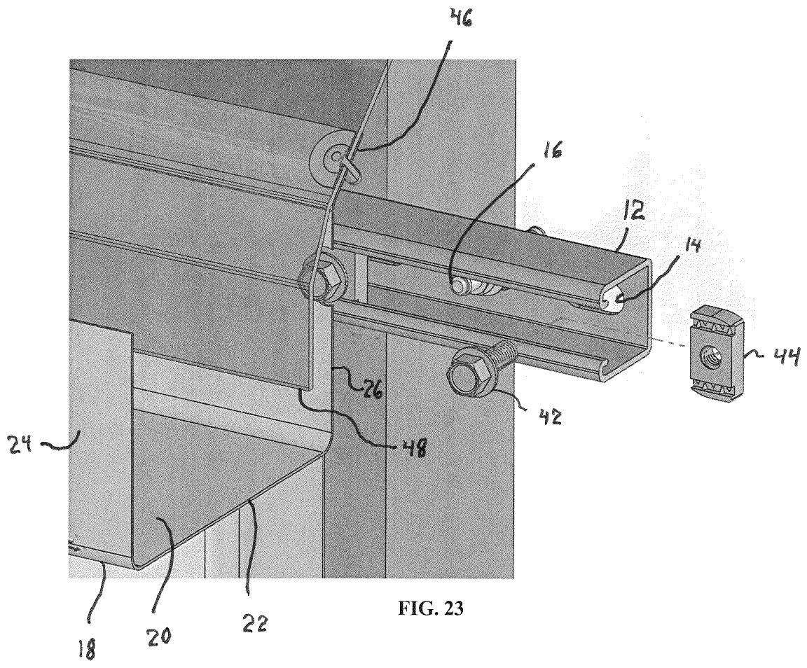

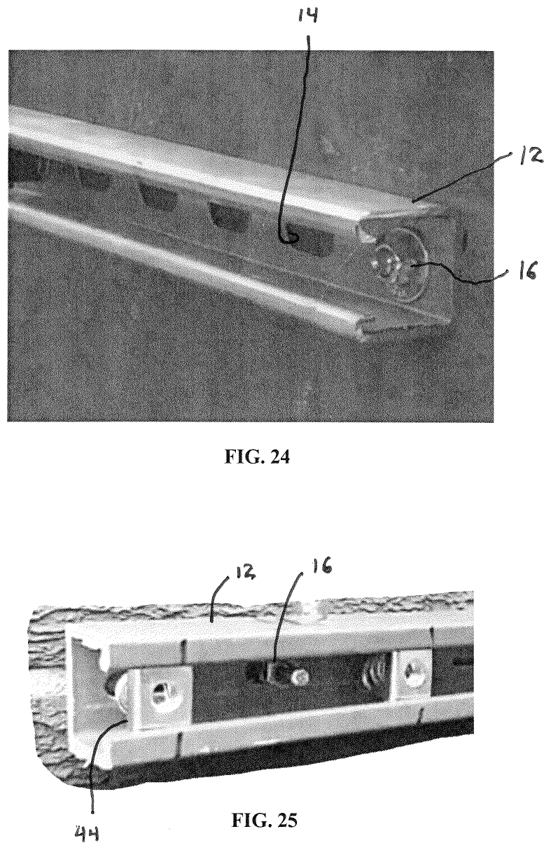

Reference should now be had to FIGS. 2-27 of the drawings, which show not only the various components of the filter system 10 of the present invention but also its installation within a storm vault 2 having a curbside opening 4, such as shown in FIG. 1 of the drawings. The filter system 10 includes a strut channel 12 which is used for mounting the other components of the filter system 10. The strut channel 12 preferably comes in four foot lengths, although strut channels 12 of other lengths may be used, or two or more strut channels 12 may be combined and arranged end-to-end to provide any desired length of strut channels 12. Preferably, the strut channel 12 is Part No. 3310T57 distributed by McMaster-Carr Supply Company of Douglasville, Georgia. The strut channel 12 comes in various lengths and is made from zinc-plated steel, galvanized steel, stainless steel, aluminum or fiberglass. The strut channel 12 includes a plurality of slotted holes 14 formed through the thickness of the back wall thereof and periodically spaced along the entire length of the strut channel 12. The slotted holes 14 are provided for mounting the strut channel 12 to an inner wall of the storm vault 2. The strut channel 12 is shown in FIGS. 10F, 12, 20 and 22-25 of the drawings.

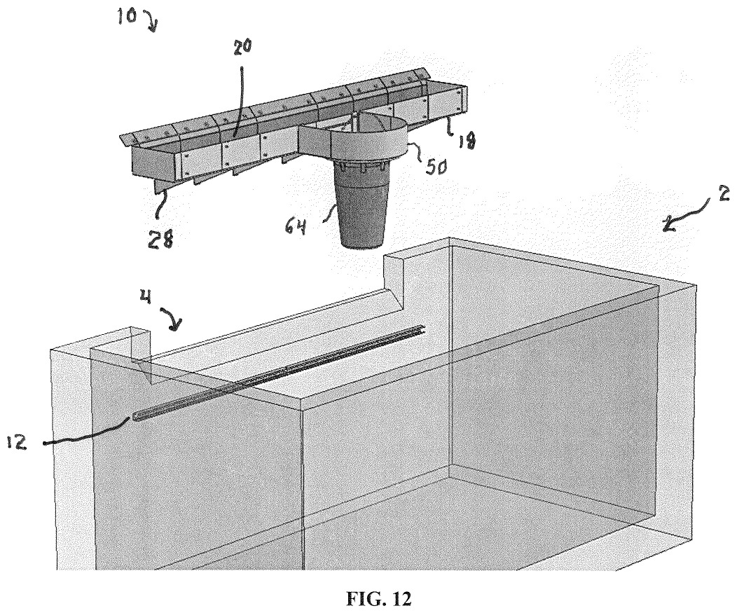

More specifically, the strut channel 12 may be cut with a saw to a desired length, or joined end-to-end with another length of strut channel 12, so that the strut channel 12, or combination of strut channels 12, extend entirely across the width of the curbside opening 4 of the storm vault 2. The manhole cover 8 or steel grate is removed from the top cover of the storm vault 2 to uncover the access opening 6 to the interior cavity of the storm vault 2. As shown in FIGS. 12 and 22-25, the installer of the filter system 10 of the present invention enters the storm vault 2 through the access opening 6. There, he positions a desired length of strut channel 12 horizontally about four inches below the curbside opening 4, and affixes a desired length of strut channel 12, or combination of end-to-end strut channels 12, to the inner surface of the front wall of the storm vault 2 using concrete anchors 16 that pass through the slotted holes 14 formed in the strut channel 12. The strut channel 12 may be cut to a desired length, or combined with other strut channels 12 lengthwise, so that the length of the strut channel 12, or strut channels 12, is at least equal to the entire width of the curbside opening 4 of the storm vault 2, as shown in FIGS. 12, 14 and 19.

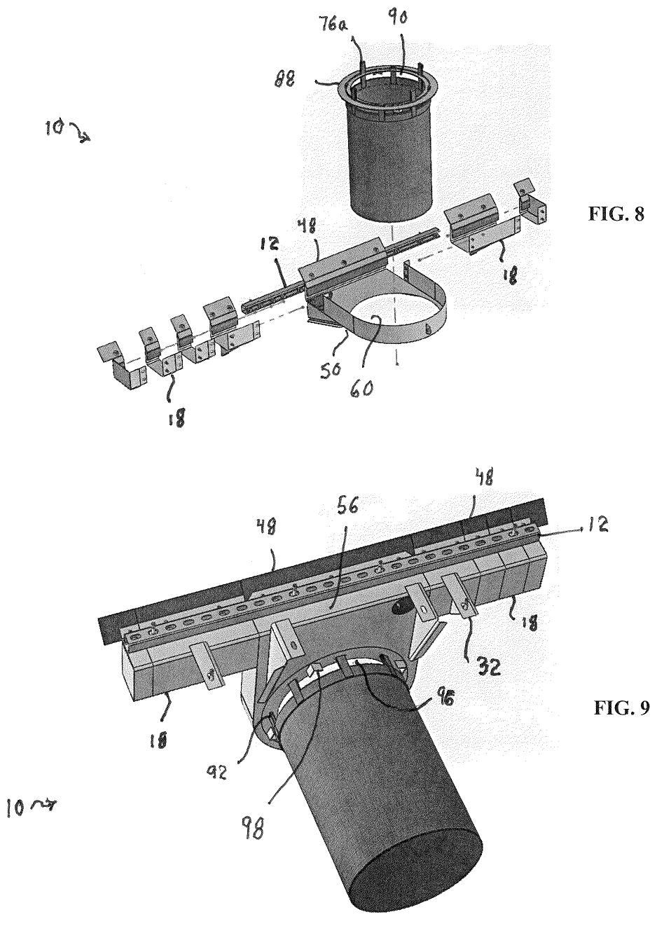

The filter system 10 of the present invention further includes straight trough sections 18 of different widths which may be interlocked with one another to define a water trough 20 for receiving storm water flowing through the curbside opening 4 and into the interior cavity of the storm vault 2. Such straight trough sections 18 are shown in FIGS. 8, 10B and many other figures of the drawings. Preferably, the trough sections 18 come in a plurality of different widths, such as three inches, six inches, twelve inches and twenty-four inches.

The straight trough sections 18 are preferably formed from sheet metal, fiberglass, or another material, and include a bottom wall 22, a front wall 24 joined perpendicularly to the bottom wall 22 and a rear wall 26 also joined perpendicularly to the bottom wall 22 and spaced apart from the front wall 24. The straight trough sections 18 may include one or more angle support brackets 28 affixed to the underside of the bottom wall 22 of the trough section 18, depending on the width of the trough section 18. More specifically, the six inch straight trough section 18 may include, for example, a single angle support bracket 28, the twelve inch straight trough section 18 may include two spaced apart angle support brackets 28 and the twenty-four inch straight trough section 18 may include several spaced apart angle support brackets 28. For the three inch straight trough section 18, no angle support brackets 28 are required because of its short width, since it will be supported by other trough sections 18, as will be explained in greater detail. The angle support brackets 28 include a first angled leg 30 and a second leg 32 joined perpendicularly to the first leg 30 at its larger end, the second leg 32 having one or more slots 34 formed through the thickness thereof to receive concrete anchors 16 for affixing the angle support brackets 28 to the inner surface of the front wall of the storm vault 2, if such is desired. In any event, the slotted second leg 32 of the angle support brackets 28 preferably rests against the inner surface of the storm vault wall to provide further support for the assembled filter system 10 of the present invention. Alternatively, a support bracket 28 in the form of a right angle corner brace with mutually perpendicular first and slotted second legs 30, 32 may be used to support the various trough sections of the system 10.

There are slots 36 formed in the front wall 24 of the straight trough section 18 in proximity to one lateral side thereof, and in proximity to the opposite lateral side thereof there are located rivet nuts 38 which receive machine screws. A suitable rivet nut 38 which may be used for the purpose of joining adjacent trough sections 18 together is Part No. 97467A725 also distributed by McMaster-Carr Supply Company. To join adjacent straight trough sections 18 together the rivet nuts 38 of one trough section 18 are received by corresponding aligned slots 36 formed in an adjacent trough section 18. Screws received by the rivet nuts 38 expand the nuts 38 to join adjacent straight trough sections 18 together. Accordingly, different size, or the same size, straight trough sections 18 may be joined together to provide a desired length and to define a trough 20 for receiving storm water which flows through the curbside opening 4 in the storm vault 2.

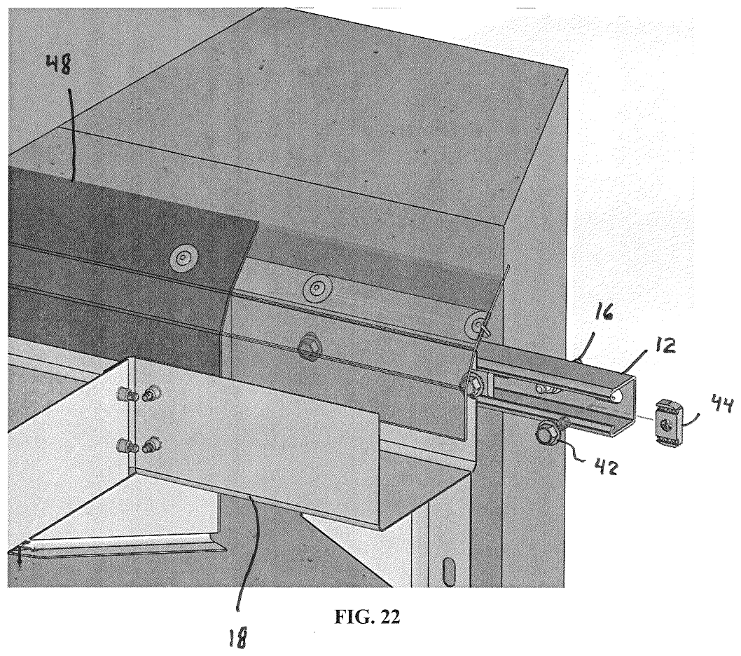

The rear wall 26 of each straight trough section 18 includes a plurality of slots 40 (or at least one slot 40 for shorter width trough sections 18) spaced apart along the width of the trough sections 18. The slots 40 receive machine screws 42 for mounting the trough sections 18 to the strut channel 12 anchored to the inner surface of the front wall of the storm vault 2. More specifically, and as shown in FIGS. 22, 23 and 25, the strut channel 12 includes a plurality of spring-biased channel nuts 44 mounted therein and slidably positionable along the length thereof. These spring-biased channel nuts 44 may be, for example, Part No. 3259T11 also distributed by McMaster-Carr Supply Company.

The number of channel nuts 44 used, and the arrangement of the channel nuts 44 within the strut channel 12, or strut channels 12, are such that each channel nut 44 is positioned along the strut channel 12 to be in alignment with the slots 40 of the various-sized interconnected trough sections 18. Machine screws 42 pass through the slots 40 in the rear walls 26 of the trough sections 18 and into aligned channel nuts 44 to secure the trough sections 18, once interconnected, to the strut channel 12 anchored to the inner surface of the front wall of the storm vault 2 and beneath the curbside opening 4 thereof.

It should be realized from the foregoing description that the trough sections 18, mounted on the strut channel 12, will be spaced away from the inner surface of the front wall of the storm vault 2 by the height of the strut channel 12, which could be as much as 1 ⅝ (1.625) inches. To direct storm water which flows through the curbside opening 4 into the trough 20 defined by the interconnected trough sections 18, the rear wall 26 of each trough section 18 includes an angled free end portion 46 thereof, and a flexible, water diverting flap 48 affixed thereto.

More specifically, the rear wall 26 of each straight trough section 18 may include a free end portion 46 outwardly angled from the primary portion of the rear wall 26 defining the trough 20. A flexible, water diverting flap 48 made from a neoprene rubber or other flexible material is affixed to and supported by this angled free end portion 46 of the rear wall 26 of the trough section 18 and extends above and below the angled portion 46 and into the trough 20 defined by the trough section 18. The purpose of the flap 48 is to ensure that storm water flowing through the curbside opening 4 of the vault 2 will be diverted into the trough 20 defined by the interconnected straight trough sections 18 and to bridge the gap between the rear wall 26 of the trough section 18 and the inner surface of the front wall of the storm vault 2, which gap is about the thickness (height) of the strut channel 12. The flexible, water diverting flap 48 rests against the inner surface of the front wall of the storm vault 2 and beneath the curbside opening 4 thereof.

Another major component of the filter system 10 of the present invention is the basket tray 50, as shown in FIGS. 8, 10D and several other figures of the drawings. The basket tray 50 is assembled with the straight trough sections 18 and further defines a trough 20 with these sections 18 for receiving storm water flowing through the curbside opening 4 of the storm vault 2.

As can be seen from the aforementioned figures, the basket tray 50 includes a bottom wall 52, a front wall 54, which may be curved in the form of a semi-circle and is generally U-shaped when viewed from above, extending upwardly and perpendicularly from the top surface of the bottom wall 52, and a rear wall 56 joined to and extending upwardly and perpendicularly from the top surface of the bottom wall 52. The rear wall 56 of the basket tray 50 is formed generally with the same shape as the rear walls 26 of the straight trough sections 18 and includes an angled free end portion 46 extending from the primary portion of the rear wall 56 and to which is attached a flexible, water diverting flap 48 in the same manner as the flaps 48 are attached to the trough sections 18. Thus, when assembled with the interconnected trough sections 18 of the filter system 10, the basket tray 50 defines with the trough sections 18 a trough 20 into which storm water flowing through the curbside opening 4 flows and is captured, the flexible flaps 48 ensuring that the water flows into the trough 20 of the filter system 10 and not into the gap between the trough sections 18 and basket tray 50 and the vault wall on which the filter system 10 is mounted.

Also, the basket tray 50 includes spaced apart angle support brackets 28 affixed to the underside of the bottom wall 52 thereof and positioned nearer the rear wall 56 thereof to help support the basket tray 50 on the wall of the storm vault 2. Furthermore, the free ends of the rear portions of the front wall 54 of the basket tray 50 which extend toward the rear wall 56 include bent tabs 58 having either slots 36 formed therethrough or rivet nuts 38 situated thereon so that the basket tray 50 may be joined to adjacent trough sections 18 having mating rivet nuts 38 and slots 36. Additionally, the rear wall 56 of the basket tray 50 includes slots 40 formed therethrough which receive machine screws 42. The machine screws 42 are received by spring-biased channel nuts 44 within the strut channel 12 so that the basket tray 50 may be secured to the strut channel 12 in the same way as the trough sections 18 are mounted on the strut channel 12.

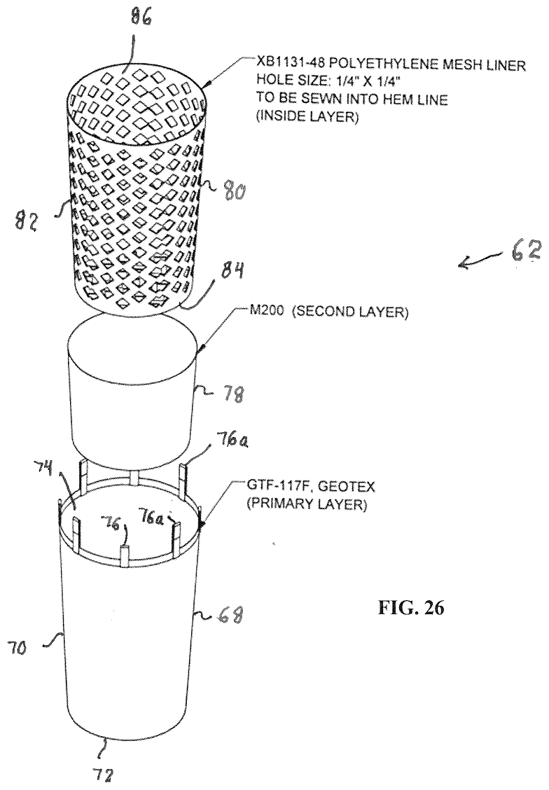

An opening 60 is formed through the thickness of the bottom wall 52 of the basket tray 50 near the free end thereof, that is, in proximity to the curved front wall 54 of the basket tray 50. As will be described in greater detail, the filtering apparatus 62 of the filter system 10 of the present invention passes through this opening 60 and is supported by the basket tray 50. One form of a filtering apparatus 62 is shown in FIG. 26 of the drawings.

More specifically, the filtering apparatus 62 of the filter system 10 of the present invention may be a sock or sack 64 formed of filtering material, and a ring 88 which supports the upper portion of the sock or sack 64. Preferably, the sack 64 is formed of three layers, although fewer layers may be used. First, there is an outer, geotextile, primary layer 68, preferably having Part Number GTF-117F, which is a woven polypropylene geotextile manufactured by US Fabrics Inc. of Cincinnati, Ohio. The primary geotextile layer 68 is generally cylindrical in form, having at least one side wall 70 (a rectangular parallelepiped version of the sack 64 would have four side walls 70), a bottom wall 72 attached to the side wall 70 and an open top end 74. Preferably, six or eight spaced apart, nylon straps 76 are sewn to the outer primary layer (the geotextile material layer) 68 and encircle the open top end 74 thereof, the nylon straps 76 extending upwardly axially therefrom, with alternate nylon straps 76a being longer than their adjacent nylon straps 76, the longer straps 76a being used for lifting the filtering apparatus 62 out of the interior cavity of the storm vault 2 through the manhole access opening 6 thereof.

Then, there is a second layer 78, which is referred to as Part Number M200, which is received within the outer, geotextile, primary layer 68 and situated near the bottom portion thereof. This second layer 78 of microfiltering material is provided for filtering very fine particles of sediment or sand, whereas the primary layer 68 of geotextile woven material filters relatively larger particles of sediment or sand than that of the second layer 78 of microfiltering material. In an alternative embodiment, this second layer 78 of microfiltering material may be omitted.

The filtering apparatus 62 also preferably includes an inner polyethylene mesh liner 80, which is preferably sewn into the hemline of the primary, geotextile woven layer 68 and is situated both within the second layer 78 and the geotextile primary layer 68. The polyethylene mesh liner 80 is cylindrical in form and includes a side wall 82 and a bottom wall 84 affixed to the side wall 82, and has an open top end 86 situated axially opposite the bottom mesh wall 84. The polyethylene mesh liner 80 provides not only support and rigidity to the primary geotextile woven layer 68 and the second layer 78 (i.e., the M200 layer), but also protects the primary layer 68 and the second layer 78 from being torn or cut when roadway or highway crews come to clean the filtering apparatus 62 and use sharp implements, such as shovels and the like, to remove debris, sediment and sand collected thereby. In an alternative embodiment of the filtering apparatus 62, this inner mesh liner 80 may be omitted.

The filtering apparatus 62 of the present invention includes a circular (or rectangular) support ring 88 or plate situated at the upper portion thereof, as shown in FIGS. 8 and 9. This support ring 88 extends radially outwardly beyond the overall diameter of the fabric sack portion 64 of the filtering apparatus 62, with the diameter of the support ring 88 being greater than that of the opening 60 formed through the bottom wall 52 of the basket tray 50 so that the underside of the support ring 88 rests on the top side of the bottom wall 52 of the basket tray 50, with the sack-type filter portion 64 being supported by and hanging downwardly therefrom. The support ring 88 includes a central opening 90 which is aligned with the open top end 74 of the filtering sack 64 to allow storm water received by the trough 20 of the filter system 10 to flow therethrough and into the inner cavity defined by the polyethylene mesh liner 80, the second layer 78 of filtering material and the outer, primary layer 68 of geotextile woven material.

More specifically, the support ring 88 includes a plurality of spaced apart slots 92 formed through the thickness thereof about the circumference of the ring 88. Each slot 92 is situated to be in alignment with a respective nylon strap 76 of the sack portion 64 of the filtering apparatus 62 so as to receive the nylon strap 76 therethrough. Situated to rest on the top side of the support ring 88 is a circular wire band 94 (see FIG. 2), which passes through the looped ends of the nylon straps 76 such that the straps 76 of the filtering sack 64 are affixed to and supported by the wire band 94 at the looped ends passing through the slots 92 of the support ring 88. The wire band 94 may include circumferential opposite end portions which overlap each other, much like a key ring, so that the filtering sack 64 and looped strap ends 76 thereof may be removed from the wire band 94 and support ring 88 for replacement of the filtering sack 64. As also clearly shown in FIGS. 2, 6, 7 and 26 of the drawings, and as mentioned previously, alternate nylon straps 76a are longer than their next adjacent straps 76 to provide an extended loop portion situated above the top side of the bottom wall 52 of the basket tray 50. The extended portions of these nylon straps 76a may be grasped by a worker by hand or using a tool to lift the filtering sack 64 with its support ring 88 from the basket tray 50 and through the manhole access opening 6 formed in the cover wall of the storm vault 2 for cleaning or replacement of the filtering sack 64.

Also, as may be seen in FIGS. 2, 6 and 7 of the drawings, the filtering sack 64 hangs below the bottom side of the bottom wall 52 of the basket tray 50 by the nylon straps 76 such that overflow channels 96 are provided between the straps 76 and between the top edge of the filtering sack 64 and the bottom side of the support ring 88. The overflow channels 96 are provided in the event that the filtering sack 64 cannot handle the volume of storm water flowing through the curbside opening 4 of the storm vault 2 and directed to the filtering sack 64 by the trough 20 defined by the interconnected trough sections 18 and the basket tray 50, such as in extreme storm conditions or if the filtering sack 64 is clogged with debris and requires cleaning.

Furthermore, as may be seen in FIG. 9 of the drawings, alignment members 98 preferably formed as short sections of L-shaped corner braces may be welded to the bottom side of the support ring 88 and spaced apart periodically about the circumference of the ring 88. Preferably, the corner edges of the alignment members 98 face radially outwardly on the ring 88 and are positioned thereon to define, together, a circumference having a diameter which is slightly less than that of the opening 60 formed in the bottom wall 52 of the basket tray 50 which receives the filtering apparatus 62. The alignment members 98 (e.g., corner braces) are used for properly positioning the filtering apparatus 62 on the basket tray 50 and within the opening 60 formed in the bottom wall 52 thereof so as to prevent a misalignment of the filtering apparatus 62 in the opening 60 and to further prevent the interior edges of the bottom wall 52 of the basket tray 50 that define the opening 60 from rubbing against the straps 76 and causing wear thereon.

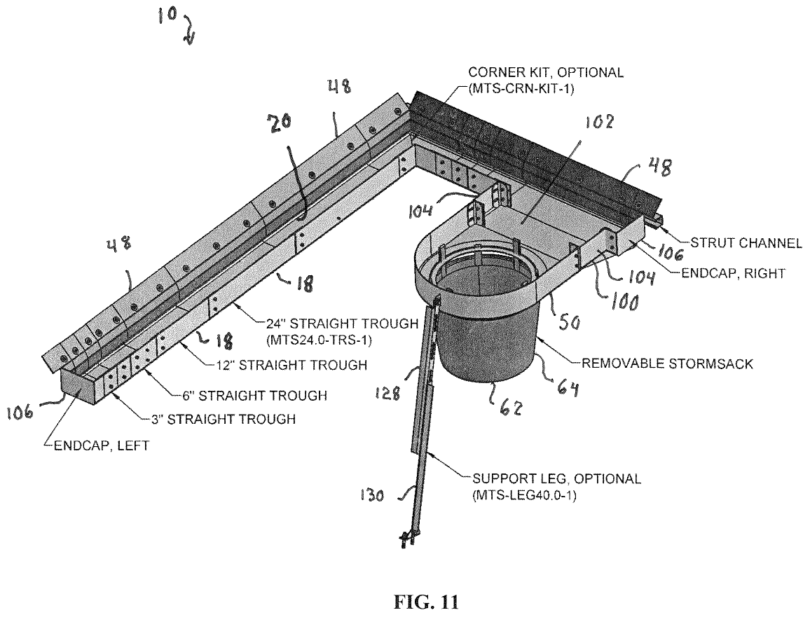

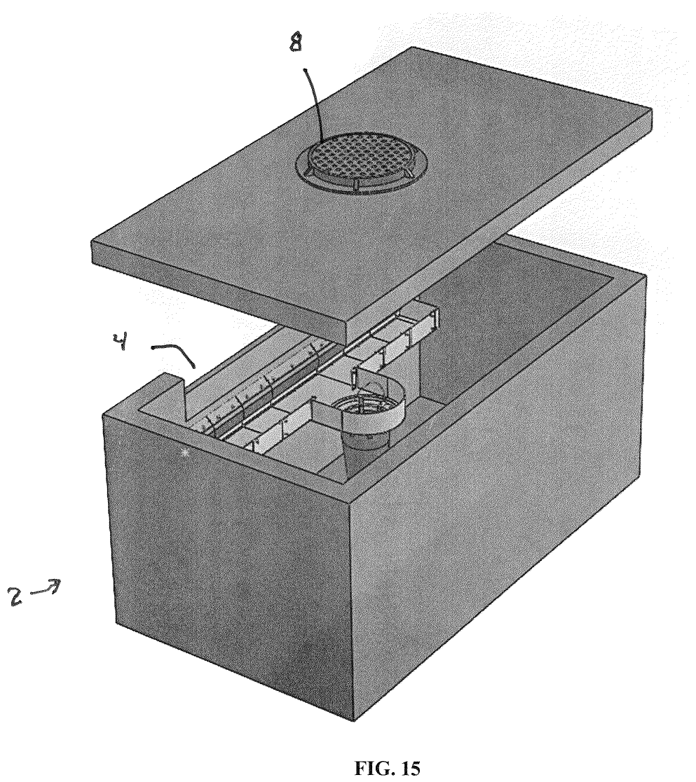

When the filter system 10 of the present invention, including the interconnected trough sections 18 thereof, are properly mounted on the inner surface of the front wall of the storm vault 2 beneath the curbside opening 4 thereof, it is important that the filtering apparatus 62 (e.g., the geotextile sack 64) is situated in alignment with the vault access opening 6 covered by the manhole cover 8. Thus, and in accordance with the present invention, the basket tray 50 is provided with different lengths (i.e., the distance from the rear wall 56 thereof to the front wall 54 thereof), such as twelve inches, eighteen inches or twenty-four inches, to project a desired distance into the internal cavity of the storm vault 2. Additionally, extender plates 100 may be provided to extend outwardly the overall length of the basket tray 50, such as shown in FIG. 11 of the drawings. The extender plates 100 include a bottom wall 102, and opposite lateral walls 104 which are joined to the bottom wall 102 and extend upwardly perpendicularly therefrom. The extender plates 100, as well as the basket tray 50, may include slotted corner tabs 58 to allow the basket tray 50 and the extender plates 100 to be joined together with machine screws. Thus, with the filter system 10 of the present invention, and the provision of basket trays 50 with various lengths and extender plates 100, the filtering apparatus 62, or geotextile sack 64, may be positioned to be in alignment with the vault access opening 6 so that, when the manhole cover 8 is removed, a maintenance worker will have easy access to the filtering apparatus 62 for cleaning or replacement. The alignment of the filtering apparatus 62 of the filter system 10 and the vault access opening 6 is shown in FIGS. 15-18 of the drawings.

The filter system 10 of the present invention also includes left and right endcaps 106, such as shown in FIG. 10A of the drawings. The endcaps 106 have a bottom wall 108, a front wall 110 joined perpendicularly to the bottom wall 108, and a rear wall 112 joined similarly to the bottom wall 108, just like the straight trough sections 18 described previously, to define a short (in length), partial water trough. The rear wall 112 has an angularly disposed free end portion 46 extending from the short trough-defining primary portion of the rear wall 112 and to which is affixed a flexible, water diverting flap 48. The rear wall 112 also includes a slot 40 for receiving therethrough a machine screw 42 which is screwed into a spring-biased channel nut 44 situated within the strut channel 12 in alignment therewith to mount the endcap 106 thereon. The endcap 106 also includes a lateral end wall 114 joined to the bottom wall 108, front wall 110 and rear wall 112 to close the end of the trough 20 defined by interconnected trough sections 18. The front wall 110 also has formed therein slots 36 for receiving the rivet nuts 38 of an adjacent trough section 18 to join the endcap 106 to its adjacent trough section 18. Alternatively, the front wall 110 may have mounted thereon rivet nuts 38 which are received in slots 36 of an adjacent trough section 18 to join the endcap 106 to its adjacent trough section 18. The left endcap 106 is shown in FIG. 10A, but the right endcap 106, closing the right end of the trough 20 defined by the interconnected trough sections 18, would be structured to have the mirror image of the left endcap 106 shown in FIG. 10A. A right endcap 106 is shown in FIG. 11.

Several figures of the drawings show various forms of the filter system 10 of the present invention, with interconnected straight trough sections 18 of various widths, left and right endcaps 106 and the basket tray 50 supporting a filtering apparatus 62, all of which define together a trough 20 for receiving storm water flowing through the curbside opening 4 of the storm vault 2 and, accordingly, directing the storm water to the filtering apparatus 62 supported by the basket tray 50. As mentioned previously, in some instances, the storm vault 2 may have a curbside opening 4 that extends partially at the corner of two intersecting streets. The filter system 10 of the present invention can be configured to be installed in such a storm vault 2 and receive storm water flowing through both sides of the curbside opening 4. Such a configuration is shown in FIG. 11 of the drawings.

More specifically, a trough 20 defined by interconnected straight trough sections 18 and mounted on strut channels 12 extending horizontally beneath the curbside openings 4 formed in adjacent walls of the storm vault 2 may be fashioned. To interconnect the trough 20 defined by interconnected trough sections 18 on one wall of the storm vault 2 with the trough 20 defined by interconnected trough sections 18 on an adjacent wall of the storm vault 2, a corner trough section 116 may be used, such as shown in FIG. 10C of the drawings. Like the straight trough sections 18, the corner trough section 116 basically includes first and second straight trough sections 18 that are joined together at a 90 degree angle to define a corner water trough. More specifically, the corner trough section 116 includes a bottom wall 118, formed with first and second perpendicularly joined together segments 118a, 118b, a front wall 120, having first and second perpendicularly joined together segments 120a, 120b and which are joined to respective bottom wall segments 118a, 118b and extend upwardly perpendicularly therefrom, and a rear wall 122, formed of first and second perpendicularly joined together segments 122a, 122b and which extend upwardly and perpendicularly from respective bottom wall segments 118a, 118b. Like the straight trough section 18, each of the first and second segments 122a, 122b of the rear wall 122 of the corner trough section 116 includes an angularly disposed free end portion 46 extending from the trough-defining primary portions of respective segments 122a, 122b of the rear wall 122, and a flexible, water diverting flap 48 affixed thereto. Additionally, slots 40 are formed in the first and second segments 122a, 122b of the rear wall 122 for receiving therethrough machine screws 42 which screw into spring-biased channel nuts 44 mounted on the strut channels 12 anchored to adjacent walls of the storm vault 2. Also, like the straight trough sections 18, the perpendicularly disposed first and second segments 120a, 120b of the front wall 120 of the corner trough section 116 include rivet nuts 38 mounted thereon or slots 36 formed therein so that the corner trough section 116 may interconnect with the straight trough sections 18 or the basket tray 50 to define a trough 20 therewith for receiving storm water flowing through the corner curbside opening 4 of the storm vault 2.

If it is anticipated that the filter apparatus 62 will be receiving heavier debris and sediment carried by the storm water runoff from the street, a support leg 124 may be used to help support the basket tray 50 of the filter system 10. The support leg 124 is shown in FIGS. 10E, 10H and 11 of the drawings.

More specifically, the outer surface of the curved front wall 54 of the basket tray 50 may include a tab 126 extending outwardly therefrom, the tab 126 having an opening formed therethrough. The support leg 124 is preferably adjustable in length and formed of first and second interconnected sections 128, 130, the first section 128 having a plurality of slots formed through the thickness thereof and spaced apart along at least a portion of the length thereof, and the second section 130 having one or more protrusions extending outwardly therefrom, which protrusions may be received by and locked into place within the slots of the first section 128. The top free end of the support leg 124 may include an extended portion having an opening 132 formed therethrough so that it is connectable with the tab 126 on the basket tray 50 with a machine screw and pivotable thereon. The bottom free end of the support leg 124 includes a foot plate 134 joined thereto having holes formed through the thickness thereof and which may receive concrete anchors 16 to affix the support leg 124 to the bottom wall of the storm vault 2. The support leg 124 is adjustable in length so that it may extend from the bottom wall of the storm vault 2 to the basket tray 50 and support the basket tray 50 and filtering apparatus 62 therein, if such additional support is required.

Another component of the filter system of the present invention is a wing diverter 136. Such is shown in FIGS. 10G and 10J of the drawings. The wing diverter 136 is essentially an L-shaped member having a bottom wall 138 and a side wall 140 joined perpendicularly to the bottom wall 138. The bottom wall 138 includes slots or holes for receiving concrete anchors 16 to mount the wing diverter 136 to an inside surface of the storm vault 2. Opposite lateral sides of the side wall 140 preferably includes flexible, water diverting flaps 48 affixed thereto and extending outwardly therefrom. Some of the open-curb inlets of storm vaults 2 that will house the filter system 10 of the present invention have what are referred to as “wings”, which is an extended mouth opening, or funnel, on the roadside to collect and channel the stormwater into a smaller width subsurface vault 2. So, although the curb opening 4 seen from the street may be twelve feet long, for example, the buried water collection vault 2 may only be four feet wide. With that in mind, some of the wings can reach deeper into the side wall of the vault 2 than the width of the trough 20 of the filter system 10. This may result in storm water bypass. The wing diverter 136 helps redirect the incoming storm water to the trough 20 of the filter system 10 of the present invention.

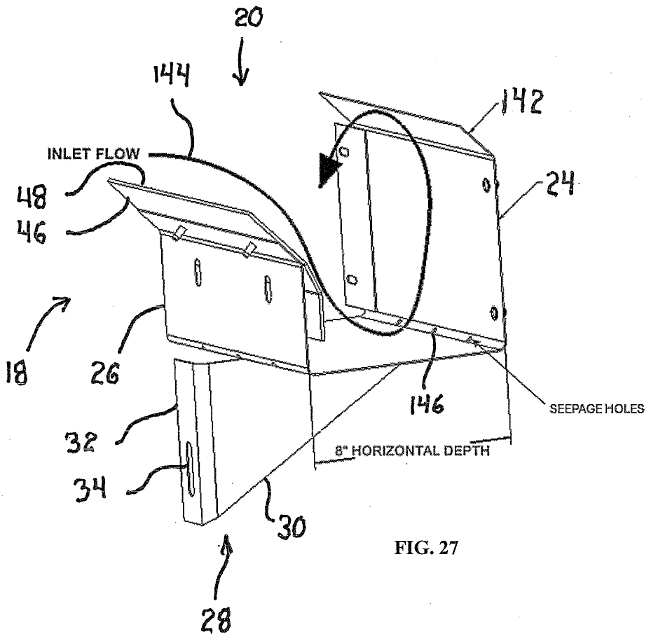

Each of the trough sections, including the straight trough section 18, the endcap 106, and the corner trough section 116, as well as the basket tray 50, may include a reverse-angled flange 142 extending upwardly from the top portion of the front wall 24 of the straight trough section 18, the front wall 110 of the endcap 106, the front wall 120 of the corner trough section 116 and the front wall 54 of the basket tray 50, which reverse-angled flange 142 is angled from the front walls to extend at least partially over the water trough defined by the trough sections 18, 106, 116 and the basket tray 50. The purpose of the reverse-angled flange 142 is to help redirect the flow of storm water through the inlet 4 of the storm vault 2 into the water trough 20 defined by the trough sections 18, 106, 116 and the basket tray 50 and to prevent overtopping. The flow of inlet water into the trough 20 defined by a straight trough section 18 and shown deflected back into the trough 20 by the reverse-angled flange 142 is illustrated by the arrow 144 in FIG. 27.

Also, as shown in FIG. 27, a plurality of spaced apart water seepage holes 146 to allow standing water in the trough 20 to seep through the holes are formed through the thickness of the bottom walls 22, 108, 118, 52 of the trough sections 18, 106, 116 and the basket tray 50, respectively, and more preferably are formed in the corners where the bottom walls 22, 108, 118, 52 meet their respective front walls 24, 110, 120, 54.

Preferably, and as mentioned previously, the filter system 10 of the present invention may be sold as kits to work with storm vaults 2 having curbside openings 4 with widths from two feet to eight feet, or larger. Each kit may include different sized straight trough sections 18, a basket tray 50 having different depths, right endcaps 106, left endcaps 106 and one or more strut channels 12, as well as a filtering apparatus 62 (referred to below as a “Stormsack”). Table I provided below shows various kits of the filter system 10 of the present invention and the components and quantities of the components provided in each kit:

TABLE I

| | QUANTITY SUPPLIED | | | | | |
|---|---|---|---|---|---|---|
| | | | | | 12 [symbol] DEEP | 18 [symbol] DEEP |
| | 3″ | 6″ | 12″ | 24″ | BASKET | BASKET |
| DESCRIPTION | TROUGH | TROUGH | TROUGH | TROUGH | TRAY | TRAY |
| 4. [symbol] TROUGH KIT | 0 | 2 | 1 | 0 | 0 | 1 |
| [symbol] TROUGH KIT [symbol] DEEP | 0 | 2 | 1 | 0 | 0 | 0 |
| [symbol] TROUGH KIT [symbol] SHALLOW | 0 | 2 | 1 | 0 | 1 | 0 |
| [symbol] TO [symbol] TROUGH | 2 | 1 | 1 | 1 | 0 | 1 |
| KIT | | | | | | |
| [symbol] TO [symbol] TROUGH | 2 | 1 | 1 | 1 | 0 | 0 |
| KIT [symbol] DEEP | | | | | | |
| 4.0 [symbol] TO [symbol] 0 TROUGH | 2 | 1 | 1 | 1 | 1 | 0 |
| KIT [symbol] SHALLOW | | | | | | |
| [symbol] TO [symbol] TROUGH | 2 | 1 | 1 | 2 | 0 | 1 |
| KIT | | | | | | |
| [symbol] TO [symbol] TROUGH | 2 | 1 | 1 | 2 | 0 | 0 |
| KIT [symbol] DEEP | | | | | | |
| [symbol] TO [symbol] TROUGH | 2 | 1 | 1 | 2 | 1 | 0 |
| KIT [symbol] SHALLOW | | | | | | |

| | QUANTITY SUPPLIED | | | | |
|---|---|---|---|---|---|
| | 24 [symbol] DEEP | | | STRUT | |
| | BASKET | END CAP | END CAP | CHANNEL | STORMSACK |
| DESCRIPTION | TRAY | (RIGHT) | (LEFT) | (48 [symbol] LENGTH) | (12 [symbol] ) |
| 4. [symbol] TROUGH | 0 | 1 | 1 | 1 | 1 |
| KIT | | | | | |
| [symbol] TROUGH | 1 | 1 | 1 | 1 | 1 |
| KIT [symbol] DEEP | | | | | |
| [symbol] TROUGH | 0 | 1 | 1 | 1 | 1 |
| KIT [symbol] SHALLOW | | | | | |
| [symbol] TO [symbol] TROUGH | 0 | 1 | 1 | 2 | 1 |
| KIT | | | | | |
| [symbol] TO [symbol] TROUGH | 1 | 1 | 1 | 2 | 1 |
| KIT [symbol] DEEP | | | | | |
| 4.0 [symbol] TO [symbol] 0 TROUGH | 0 | 1 | 1 | 2 | 1 |
| KIT [symbol] SHALLOW | | | | | |
| [symbol] TO [symbol] TROUGH | 0 | 1 | 1 | 2 | 1 |
| KIT | | | | | |
| [symbol] TO [symbol] TROUGH | 1 | 1 | 1 | 2 | 1 |
| KIT [symbol] DEEP | | | | | |
| [symbol] TO [symbol] TROUGH | 0 | 1 | 1 | 2 | 1 |
| KIT [symbol] SHALLOW | | | | | |

[symbol]

indicates data missing or illegible when filed

The filter system 10 of the present invention helps prevent debris, such as leaves, twigs, trash and other pollutants, from entering the storm water drainage system. By capturing and retaining these materials at the curb inlet, the filter system 10 protects downstream pipes, channels and water bodies from clogging. This promotes the smooth flow of storm water, reduces the risk of localized flooding and minimizes the need for costly maintenance and repairs.

Furthermore, the filter system 10 of the present invention aids in preserving water quality. Storm water runoff can carry various pollutants, including sediment, chemicals, oils and microplastics. When these contaminants are intercepted by the filter system 10 of the present invention, they are prevented from entering the drainage system and ultimately polluting natural water bodies. By reducing the amount of pollutants reaching streams, rivers and lakes, the filter system 10 of the present invention helps safeguard aquatic ecosystems and supports overall environmental health.

In summary, incorporating the filter system 10 of the present invention within storm vaults 2 having curbside openings 4 offers numerous benefits. It prevents debris from clogging the storm water drainage system, safeguards water quality by intercepting pollutants and enhances the aesthetic cleanliness of urban areas. By effectively capturing and containing debris, the filter system 10 of the present invention plays a crucial role in improving storm water management, reducing maintenance needs and protecting the environment for the benefit of both humans and ecosystems.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A storm water trough filter system, the trough filter system being mountable in a storm vault having interior walls and a storm water inlet formed in at least one of the interior walls which allows storm water to flow therethrough and into the storm vault, the storm water trough filter system comprising:
at least one trough section, the at least one trough section defining a water trough for receiving storm water flowing into the storm vault through the storm water inlet thereof;
at least one mounting bracket, the at least one mounting bracket being affixable to at least one of the interior walls of the storm vault, the at least one trough section being mountable on the at least one mounting bracket; and
a filtering apparatus, the filtering apparatus having a water permeable filtering medium;
wherein the water trough defined by the at least one trough section is in fluid communication with the water permeable filtering medium of the filtering apparatus to direct storm water received by the water trough to the filtering medium of the filtering apparatus.

2. A storm water trough filter system, the trough filter system being mountable in a storm vault having interior walls and a storm water inlet formed in at least one of the interior walls which allows storm water to flow therethrough and into the storm vault, the storm water trough filter system comprising:
at least a first trough section and a second trough section, the at least first trough section and the second trough section being joinable and configurable to define together a water trough for receiving storm water flowing into the storm vault through the storm water inlet thereof;
at least one mounting bracket, the at least one mounting bracket being affixable to at least one of the interior walls of the storm vault, the at least first trough section and the second trough section being mountable on the at least one mounting bracket; and
a filtering apparatus, the filtering apparatus having a water permeable filtering medium;
wherein the water trough defined by the at least first trough section and the second trough section is in fluid communication with the water permeable filtering medium of the filtering apparatus to direct storm water received by the water trough to the filtering medium of the filtering apparatus.

3. A storm water trough filter system as defined by claim 2, wherein at least one of the at least first trough section and the second trough section is a straight trough section.

4. A storm water trough filter system as defined by claim 3, wherein the straight trough section includes at least one support bracket supporting the straight trough section, the at least one support bracket including a first leg and a second leg joined generally perpendicularly to the first leg, the second leg having one or more slots formed through the thickness thereof to receive anchors for affixing the at least one support bracket to the at least one of the interior walls of the storm vault on which the storm water trough filter system is mountable.

5. A storm water trough filter system as defined by claim 3, wherein the straight trough section includes at least one support bracket supporting the straight trough section, the at least one support bracket including a first leg and a second leg joined generally perpendicularly to the first leg, the second leg being engageable with the at least one of the interior walls of the storm vault on which the storm water trough filter system is mountable.

6. A storm water trough filter system as defined by claim 3, wherein the straight trough section includes a bottom wall, a front wall joined to the bottom wall and a rear wall joined to the bottom wall and spaced apart from the front wall.

7. A storm water trough filter system as defined by claim 6, wherein the rear wall of the straight trough section includes a primary portion joined to the bottom wall and a free end portion outwardly angled from the primary portion.

8. A storm water trough filter system as defined by claim 7, wherein the straight trough section includes a flexible, water diverting flap affixed to and supported by the angled free end portion of the rear wall of the straight trough section to help ensure that storm water flowing through the inlet of the storm vault will be diverted into the trough defined by the straight trough section.

9. A storm water trough filter system as defined by claim 8, wherein the straight trough section, when mounted on the mounting bracket, is spaced from the at least one interior wall of the storm vault on which the water trough filter system is mounted to define a gap between the rear wall of the straight trough section and the at least one interior wall; and
wherein the flexible, water diverting flap is dimensioned in width to bridge the gap between the rear wall of the straight trough section and the at least one interior wall of the storm vault on which the water trough filter system is mounted.

10. A storm water trough filter system as defined by claim 6, wherein the front wall of the straight trough section has a top portion; and
wherein the straight trough section includes a reverse-angled flange extending upwardly from the top portion of the front wall and angularly therefrom to reside over at least a portion of the water trough defined by the straight trough section, the reverse-angled flange being provided to divert water into the trough defined by the straight trough section.

11. A storm water trough filter system as defined by claim 10, wherein the straight trough section has a plurality of spaced apart water seepage holes formed in a corner defined where the front wall of the straight trough section meets the bottom wall of the straight trough section.

12. A storm water trough filter system as defined by claim 3, which further comprises:
a basket tray, the filtering apparatus being supportable by the basket tray, the basket tray being mountable on the at least one mounting bracket, the basket tray being joinable to the straight trough section and further defining the water trough therewith, the water trough defined by the straight trough section and the basket tray being in fluid communication with the filtering medium of the filter apparatus supportable by the basket tray.

13. A storm water trough filter system as defined by claim 12, wherein the basket tray includes at least one support bracket supporting the basket tray, the at least one support bracket including a first leg and a second leg joined generally perpendicularly to the first leg, the second leg having one or more slots formed through the thickness thereof to receive anchors for affixing the at least one support bracket to the at least one of the interior walls of the storm vault on which the storm water trough filter system is mountable.

14. A storm water trough filter system as defined by claim 12, wherein the basket tray includes at least one support bracket supporting the basket tray, the at least one support bracket including a first leg and a second leg joined generally perpendicularly to the first leg, the second leg being engageable with the at least one of the interior walls of the storm vault on which the storm water trough filter system is mountable.

15. A storm water trough filter system as defined by claim 12, wherein the basket tray includes a bottom wall, a front wall extending upwardly from the bottom wall, and a rear wall joined to and extending upwardly from the bottom wall.

16. A storm water trough filter system as defined by claim 15, wherein the rear wall of the basket tray includes a primary portion joined to the bottom wall of the basket tray and a free end portion outwardly angled from the primary portion.

17. A storm water trough filter system as defined by claim 16, wherein the basket tray includes a flexible, water diverting flap affixed to and supported by the angled free end portion of the rear wall of the basket tray to help ensure that storm water flowing through the inlet of the storm vault will be diverted into the trough defined by the straight trough section and the basket tray.

18. A storm water trough filter system as defined by claim 15, wherein the front wall of the basket tray has a top portion; and
wherein the basket tray includes a reverse-angled flange extending upwardly from the top portion of the front wall and angularly therefrom to reside over at least a portion of the water trough defined by the basket tray, the reverse-angled flange being provided to divert water into the trough defined by the basket tray.

19. A storm water trough filter system as defined by claim 18, wherein the basket tray has a plurality of spaced apart water seepage holes formed in a corner defined where the front wall of the basket tray meets the bottom wall of the basket tray.

20. A storm water trough filter system as defined by claim 15, wherein an opening is formed through the thickness of the bottom wall of the basket tray and in proximity to the front wall of the basket tray; and
wherein the filtering apparatus and filtering medium thereof pass through the opening and are supported by the basket tray.

21. A storm water trough filter system as defined by claim 15, wherein the filtering apparatus includes a support ring, and wherein the filtering medium of the filtering apparatus is attached to the support ring and is supported thereby, the support ring being adapted to rest on the bottom wall of the basket tray.

22. A storm water trough filter system as defined by claim 21, wherein the filtering medium of the filtering apparatus is formed as a sack supported by and hanging from the basket tray, the filtering medium being formed of at least one layer of a geotextile material and including at least one side wall, a bottom wall attached to the at least one side wall, and an open top end.

23. A storm water trough filter system as defined by claim 12, which further comprises:
at least one extender plate, the at least one extender plate being joinable to the basket tray to extend the overall length of the basket tray such that the basket tray extends a desired distance into the storm vault measured outwardly from the at least one interior wall of the storm vault on which the storm water trough filter system is mountable, the at least one extender plate including a bottom wall and opposite lateral walls which are joined to the bottom wall and extend upwardly therefrom, the at least one extender plate defining an extension of the water trough defined by the straight trough section and the basket tray.

24. A storm water trough filter system as defined by claim 12, wherein the storm vault includes a bottom wall, and wherein the storm water trough filter system further comprises:
a support leg used to help support the basket tray, the support leg extending between and being engageable with the basket tray and the bottom wall of the storm vault.

25. A storm water trough filter system as defined by claim 24, wherein the support leg is adjustable in axial length.

26. A storm water trough filter system as defined by claim 25, wherein the support leg includes first and second interconnected sections, the first section having a plurality of slots formed through the thickness thereof and spaced apart along at least a portion of the length thereof, and the second section having one or more protrusions extending outwardly therefrom, the one or more protrusions being receivable by one or more of the slots of the first section.

27. A storm water trough filter system as defined by claim 2, wherein the at least first trough section and the second trough section includes a first straight trough section and a second straight trough section, the first straight trough section being joinable to the second straight trough section to define together the water trough.

28. A storm water trough filter system as defined by claim 27, wherein the first straight trough section has a first length;
wherein the second straight trough section has a second length; and
wherein the first length of the first straight trough section is different from the second length of the second straight trough section.

29. A storm water trough filter system as defined by claim 2, wherein at least one of the at least first trough section and the second trough section is a corner trough section.

30. A storm water trough filter system as defined by claim 29, wherein the corner trough section includes a first section and a second section which are joined together at substantially a 90 degree angle.

31. A storm water trough filter system as defined by claim 30, wherein the corner trough section includes a bottom wall formed with first and second substantially perpendicularly joined together segments, a front wall having first and second substantially perpendicularly joined together segments and which are joined to the respective first and second bottom wall segments and extend upwardly therefrom, and a rear wall formed of first and second substantially perpendicularly joined together segments and which extend upwardly from the respective first and second bottom wall segments.

32. A storm water trough filter system as defined by claim 31, wherein each of the first and second segments of the rear wall of the corner trough section includes a primary portion joined to the respective first and second bottom wall segments and a free end portion outwardly angled from the primary portion.

33. A storm water trough filter system as defined by claim 32, wherein the corner trough section includes a flexible, water diverting flap affixed to and supported by the angled free end portion of each of the first and second segments of the rear wall of the corner trough section to help ensure that storm water flowing through the inlet of the storm vault will be diverted into the trough defined by the corner trough section.

34. A storm water trough filter system as defined by claim 31, wherein the front wall of the corner trough section has a top portion; and
wherein the corner trough section includes a reverse-angled flange extending upwardly from the top portion of the front wall and angularly therefrom to reside over at least a portion of the water trough defined by the corner trough section, the reverse-angled flange being provided to divert water into the trough defined by the corner trough section.

35. A storm water trough filter system as defined by claim 34, wherein the corner trough section has a plurality of spaced apart water seepage holes formed in a corner defined where the front wall of the corner trough section meets the bottom wall of the corner trough section.

36. A storm water trough filter system as defined by claim 3, which further comprises:
at least one endcap, the at least one endcap being joinable to the straight trough section and further defining a partial water trough in fluid communication with the water trough defined by the straight trough section, the at least one endcap having an end wall closing an axial end of the water trough defined by the straight trough section when joined thereto.

37. A storm water trough filter system as defined by claim 36, wherein the at least one endcap includes a bottom wall, a front wall joined to the bottom wall and a rear wall joined to the bottom wall and spaced apart from the front wall, the end wall being joined to the front wall, the bottom wall and the rear wall of the at least one endcap.

38. A storm water trough filter system as defined by claim 37, wherein the rear wall of the at least one endcap includes a primary portion joined to the bottom wall and a free end portion outwardly angled from the primary portion.

39. A storm water trough filter system as defined by claim 38, wherein the at least one endcap includes a flexible, water diverting flap affixed to and supported by the angled free end portion of the rear wall of the at least one endcap to help ensure that storm water flowing through the inlet of the storm vault will be diverted into the partial trough defined by the at least one endcap.

40. A storm water trough filter system as defined by claim 37, wherein the front wall of the at least one endcap has a top portion; and
wherein the at least one endcap includes a reverse-angled flange extending upwardly from the top portion of the front wall and angularly therefrom to reside over at least a portion of the water trough defined by the at least one endcap, the reverse-angled flange being provided to divert water into the trough defined by the at least one endcap.

41. A storm water trough filter system as defined by claim 40, wherein the at least one endcap has a plurality of spaced apart water seepage holes formed in a corner defined where the front wall of the at least one endcap meets the bottom wall of the at least one endcap.

42. A storm water trough filter system, the trough filter system being mountable in a storm vault having interior walls and a storm water inlet formed in at least one of the interior walls which allows storm water to flow therethrough and into the storm vault, the storm water trough filter system comprising:
a plurality of trough sections, the trough sections being joinable and configurable to define together a water trough for receiving storm water flowing into the storm vault through the storm water inlet thereof;
at least one mounting bracket, the at least one mounting bracket being affixable to at least one of the interior walls of the storm vault, at least some of the trough sections being mountable on the at least one mounting bracket;
a filtering apparatus, the filtering apparatus having a water permeable filtering medium, wherein the water trough defined by the trough sections is in fluid communication with the water permeable filtering medium of the filtering apparatus to direct storm water received by the water trough to the filtering medium of the filtering apparatus; and
a basket tray, the filtering apparatus being supportable by the basket tray, the basket tray being mountable on the at least one mounting bracket, the basket tray being joinable to at least one of the trough sections and further defining the water trough therewith, the water trough defined by the trough sections and the basket tray being in fluid communication with the filtering medium of the filter apparatus supportable by the basket tray.
